(19) United States
(12) Patent Application Publication
(10) Pub. No.: US 2011/0028642 A1
(43) Pub. Date: Feb. 3, 2011

(54) POLYURETHANE ELASTOMERS

(75) Inventors: Rui Xie, Alpharetta, GA (US); Debkumar Bhattacharjee, Lake Jackson, TX (US); John N. Argyropoulos, Midland, MI (US)

Correspondence Address: The Dow Chemical Company, P.O. BOX 1967, 2040 Dow Center, Midland, MI, 48641, US

(73) Assignee: Dow Global Technologies Inc., Midland, MI (US)

(21) Appl. No.: 12/936,746

(22) PCT Filed: Apr. 8, 2009
(86) PCT No.: PCT/US09/39902

§ 371 Date: Oct. 7, 2010

Related U.S. Application Data
(60) Provisional application No. 61/043,558, filed on Apr. 9, 2008.

(51) Int. Cl. C08G 18/75; C08G 18/10; C09D 175/04

(52) U.S. Cl. 524/590; 528/85; 528/73; 528/67

(57) ABSTRACT

A polyurethane elastomer is provided. The elastomer is the reaction product of at least a prepolymer and a chain extender, where the prepolymer is the reaction product of at least one polyol and at least one aliphatic diisocyanate. The chain extender is at least one of a diol or a non-aromatic diamine.

### CROSS-REFERENCE TO RELATED APPLICATIONS

This application claims benefit of U.S. Provisional Patent Application Ser. No. 61/043,558, filed Apr. 9, 2008, entitled “POLYURETHANE ELASTOMERS” which is herein incorporated by reference.

### BACKGROUND

1. Field of the Invention

Embodiments of the present invention generally relate to polyurethane elastomers; more specifically, to polyurethane elastomers made from aliphatic isocyanates.

2. Description of the Related Art

Polyurethane elastomers based on aliphatic diisocyanates are used in limited applications due to higher cost and lower mechanical strength compared to polyurethane elastomers based on aromatic diisocyanates. Aliphatic diisocyanates, such as 1,6-hexane diisocyanate (HDI), methylene bis (p-cyclohexyl isocyanate) (H₁₂MDI) and isophorone diisocyanate (IPDI) are more costly to produce compared to aromatic diisocyanates, such as 4,4′-diphenylmethane diisocyanate (MDI) and toluene diisocyanate (TDI). In addition to cost, polyurethanes based on aliphatic diisocyanates may have decreased mechanical strength and heat resistance compared to their aromatic counterparts. The cost and performance may limit the use of aliphatic diisocyanate based elastomers to a handful of applications even though aliphatic elastomers exhibit greater light stability and increased resistance to hydrolysis and thermal degradation than do the elastomers based on aromatic diisocyantes.

Therefore, there is a need for elastomers that are cost effective and have increased mechanical properties while maintaining increased light stability, increased resistance to hydrolysis, and increased heat resistance.

### SUMMARY

The embodiments of the present invention provide for a polyurethane elastomer including the reaction product of at least one prepolymer and at least one chain extender. The prepolymer includes the reaction product of at least one polyol and at least one aliphatic diisocyanate. The chain extender may be at least one of a diol or a non-aromatic diamine. The aliphatic diisocyanate may be a mixture of 1,3-bis(isocyanato-methyl)cyclohexane and 1,4-bis(isocyanatomethyl)cyclohexane. The polyurethane elastomer may have a change in elastic modulus of less than about 94% over a temperature range of between about 0° C. and about 150° C. Over a range of between about 0° C. and about 100° C. the change may be less than about 90%. Over a range of at least one of between about 0° C. and about 100° C., and between about 100° C. and about 150° C., the change may be less than about 90%. Over a range of between about 100° C. and about 125° C. the change may be less than about 70%. Over a range of between about 75° C. and about 125° C. the change may be less than about 85%. Over a range of between about 75° C. and about 125° C. the change may be less than about 85%. Over a range of between about 50° C. and about 100° C. the change may be less than about 85%. Over a range of between about 25° C. and about 75° C. the change may be less than about 70%. Over a range of between about 0° C. and about 75° C. the change may be less than about 75%. Over a range of between about 0° C. and about 50° C. the change may be less than about 70%.

In another embodiment of the invention, an article is provided which may include the elestomer above. The article may be one of a film, a coating, a laminate, glasses, a lens, a ballistic glass, an architecturally shaped window, a hurricane window, an armor, a golf ball, a bowling ball, a rollerblade wheel, a roller-skate wheel, a skate-board wheel, a greenhouse cover, a floor coating, an outdoor coatings, a photovoltaic cell, a face mask, a personal protection gear, and a privacy screen.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

FIG. 1 is a graph displaying the elastic modulus (shear storage modulus) of elastomers containing 45% hard segment content for ADI based elastomers with varying stoichiometry using BDO as the chain extender.

FIG. 2 is a graph displaying the tan δ values of elastomers containing 45% hard segment content for ADI based elastomers with varying stoichiometry using BDO as the chain extender.

### DETAILED DESCRIPTION

Embodiments of the present invention provide for elastomers that are cost effective and have good mechanical properties while at the same time maintaining good light stability, good resistance to hydrolysis, and good heat resistance. The eleastomers according to the embodiments of the present invention may be made through a “two-step process,” in which the fist step includes reacting at least one kind of polyol with at least one kind of aliphatic diisocyanate to form a prepolymer. In the second step, the prepolymer is reacted with a diol or a non-aromatic diamine chain extender to form a polyurethane elastomer. As a result of the two-step process, the structure of polyurethane elastomers consists of alternating blocks of flexible chains of low glass-transition temperature (soft segments) and highly polar, relatively rigid blocks (hard segments). The soft segments are derived from aliphatic polyethers or polyesters and have glass-transition temperatures below room temperature. The hard segments are formed by the reaction of the isocyanate with the chain extender. Separation of these two dissimilar blocks produces regions of hydrogen-bonded hard domains that act as cross-linking points for the soft blocks.

The polyols useful in the embodiments of the present invention are compounds which contain two or more isocyanate reactive groups, generally active-hydrogen groups, such as —OH, primary or secondary amines, and —SH. Representative of suitable polyols are generally known and are described in such publications as High Polymers, Vol. XVI; “Polyurethanes, Chemistry and Technology”, by Saunders and Frisch, Interscience Publishers, New York, Vol. I, pp. 32-42, 44-54 (1962) and Vol II. Pp. 5-6, 198-199 (1964); Organic Polymer Chemistry by K. J. Saunders, Chapman and Hall, London, pp. 323-325 (1973); and Developments in Polyurethanes, Vol. I, J. M. Burst, ed., Applied Science Publishers, pp. 1-76 (1978). Representative of suitable polyols include polyester, polylactone, polyether, polyolefin, polycarbonate polyols, and various other polyols.

Illustrative of the polyester polyols are the poly(alkylene alkanedioate) glycols that are prepared via a conventional esterification process using a molar excess of an aliphatic glycol with relation to an alkanedioic acid. Illustrative of the glycols that can be employed to prepare the polyesters are ethylene glycol, diethylene glycol, propylene glycol, dipropylene glycol, 1,3-propanediol, 1,4-butanediol and other butanediols, 1,5-pentanediol and other pentane diols, hexanediols, decanediols, dodecanediols and the like. Preferably the aliphatic glycol contains from 2 to about 8 carbon atoms. Illustrative of the dioic acids that may be used to prepare the polyesters are maleic acid, malonic acid, succinic acid, glutaric acid, adipic acid, 2-methyl-1,6-hexanoic acid, pimelic acid, suberic acid, dodecanedioic acids, and the like. Preferably the alkanedioic acids contain from 4 to 12 carbon atoms. Illustrative of the polyester polyols are poly(hexanediol adipate), poly(butylene glycol adipate), poly(ethylene glycol adipate), poly(diethylene glycol adipate), poly(hexanediol oxalate), poly(ethylene glycol sebecate), and the like.

Polylactone polyols useful in the practice of the embodiments of the invention are the di- or tri- or tetra-hydroxyl in nature. Such polyol are prepared by the reaction of a lactone monomer; illustrative of which is γ-valerolactone, ε-caprolactone, γ-methyl-ε-caprolactone, ζ-enantholactone, and the like; is reacted with an initiator that has active hydrogen-containing groups; illustrative of which is ethylene glycol, diethylene glycol, propanediols, 1,4-butanediol, 1,6-hexanediol, trimethylolpropane, and the like. The production of such polyols is known in the art, see, for example, U.S. Pat. Nos. 3,169,945, 3,248,417, 3,021,309 to 3,021,317. The preferred lactone polyols are the di-, tri-, and tetra-hydroxyl functional ε-caprolactone polyols known as polycaprolactone polyols.

The polyether polyols include those obtained by the alkoxylation of suitable starting molecules with an alkylene oxide, such as ethylene, propylene, butylene oxide, or a mixture thereof. Examples of initiator molecules include water, ammonia, aniline or polyhydric alcohols such as dihyric alcohols having a molecular weight of 62-399, especially the alkane polyols such as ethylene glycol, propylene glycol, hexamethylene diol, glycerol, trimethylol propane or trimethylol ethane, or the low molecular weight alcohols containing ether groups such as diethylene glycol, triethylene glycol, dipropylene glyol or tripropylene glycol. Other commonly used initiators include pentaerythritol, xylitol, arabitol, sorbitol mannitol and the like. Preferably a poly(propylene oxide) polyols include poly(oxypropylene-oxyethylene) polyols is used. Preferably the oxyethylene content should comprise less than about 40 weight percent of the total and preferably less than about 25 weight percent of the total weight of the polyol. The ethylene oxide can be incorporated in any manner along the polymer chain, which stated another way means that the ethylene oxide can be incorporated either in internal blocks, as terminal blocks, may be randomly distributed along the polymer chain, or may be randomly distributed in a terminal oxyethylene-oxypropylene block. These polyols are conventional materials prepared by conventional methods.

Other polyether polyols include the poly(tetramethylene oxide) polyols, also known as poly(oxytetramethylene) glycol, that are commercially available as diols. These polyols are prepared from the cationic ring-opening of tetrahydrofuran and termination with water as described in Dreyfuss, P. and M. P. Dreyfuss, Adv. Chem. Series, 91, 335 (1969).

Polycarbonate containing hydroxyl groups include those known per se such as the products obtained from the reaction of diols such as propanediol-(1,3), butanediols-(1,4) and/or hexanediol-(1,6), diethylene glycol, triethylene glycol or tetraethylene glycol with diarylcarbonates, e.g. diphenylcarbonate or phosgene.

Illustrative of the various other polyols suitable for use in embodiments of the invention are the styrene/allyl alcohol copolymers; alkoxylated adducts of dimethylol dicyclopentadiene; vinyl chloride/vinyl acetate/vinyl alcohol copolymers; vinyl chloride/vinyl acetate/hydroxypropyl acrylate copolymers, copolymers of 2-hydroxyethylacrylate, ethyl acrylate, and/or butyl acrylate or 2-ethylhexyl acrylate; copolymers of hydroxypropyl acrylate, ethyl acrylate, and/or butyl acrylate or 2-ethylhexylacrylate, and the like.

Generally for use in embodiments of the invention, the hydroxyl terminated polyol has a number average molecular weight of 200 to 10,000. Preferably the polyol has a molecular weight of from 300 to 7,500. More preferably the polyol has a number average molecular weight of from 400 to 5,000. Based on the initiator for producing the polyol, the polyol will have a functionality of from 1.5 to 8. Preferably, the polyol has a functionality of 2 to 4. For the production of elastomers based on the dispersions of embodiments of the present invention, it is preferred that a polyol or blend of polyols is used such that the nominal functionality of the polyol or blend is equal or less than 3.

The isocyanate composition of the various embodiments of the present invention may be prepared from bis(isocyanatomethyl)cyclohexane. Preferably, the isocyanate comprises two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, with the proviso the isomeric mixture comprises at least about 5 weight percent of the 1,4-isomer. In a preferred embodiment, the composition contains a mixture of 1,3- and 1,4-isomers. The preferred cycloaliphatic diisocyanates are represented by the following structural Formulas I through IV:

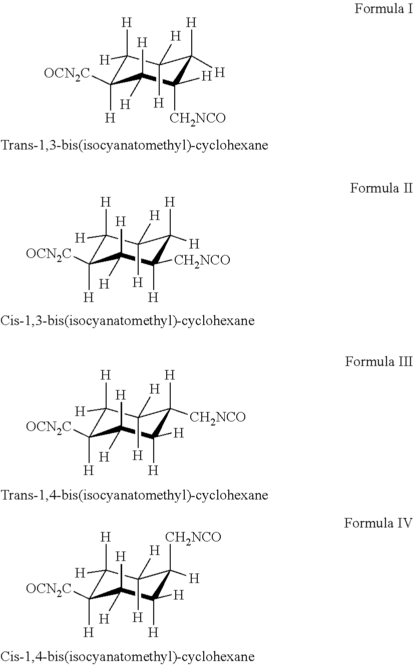

These cycloaliphatic diisocyanates may be used in a mixture as manufactured from, for example, the Diels-Alder reaction of butadiene and acrylonitrile, subsequent hydroformylation, then reductive amination to form the amine, that is, cis-1,3-bis(isocyanotomethyl)cyclohexane, trans-1,3-bis(isocyanotomethyl)cyclohexane, cis-1,4-bis(isocyanotomethyl)cyclohexane and trans-1,4-bis(isocyanotomethyl)cyclohexane, followed by reaction with phosgene to form the cycloaliphatic diisocyanate mixture. The preparation of the bis(aminomethyl)cyclohexane is described in U.S. Pat. No. 6,252,121.

In one embodiment, the isocyanurate isocyanate composition is derived from a mixture containing from 5 to 90 wt percent of the 1,4-isomers. Preferably the isomeric mixture comprises 10 to 80 wt percent of the 1,4-isomers. More preferably at least 20, most preferably at least 30 and even more preferably at least 40 weight percent of the 1,4-isomers.

Other aliphatic isocyanates may also be included and can range from 0.1 percent to 50 percent or more, preferably from 0 percent to 40 percent, more preferably from 0 percent to 30 percent, even more preferably from 0 percent to 20 percent and most preferably from 0 percent to 10 percent by weight of the total polyfunctional isocyanate used in the formulation. Examples of other aliphatic isocyanates include, 1,6-hexamethylene diisocyanate, isophorone diisocyanate (IPDI), tetramethylene-1,4-diisocyanate, methylene bis(cyclohexaneisocyanate) (H₁₂MDI), cyclohexane 1,4-diisocyanate, and mixtures thereof.

In one embodiment of the invention, the starting isocyanates include a mixture of 1,3- and 1,4-bis(isocyanatomethyl)cyclohexane monomers with an additional cyclic or alicyclic isocyanate. In one embodiment, the 1,3- and 1,4-bis(isocyanatomethyl)cyclohexane monomer are used in combination with 1,6-hexamethylene diisocyanate (HDI), isophorone diisocyanate (IPDI), H₁₂MDI, or a mixture thereof. When HDI and/or IPDI is used as an additional polyfunctional isocyanate in addition to the bis(isocyanatomethyl)cyclohexane, HDI and/or IPDI may be added in an amount of up to about 50 percent by weight of the total polyfunctional isocyanate. In one embodiment, HDI and/or IPDI may be added to comprises up to about 40 percent by weight of the total polyfunctional isocyanate. In one embodiment, HDI and/or IPDI may be added to comprise up to about 30 percent by weight of the total polyfunctional isocyanate.

The at isocyanate, or mixture of isocyanates, may be combined with the polyol at ratios such that the ratios of cyanate groups of the isocyanate to the ratio of cyanate reactive groups of the polyol (NCO:OH ratio) is between about 2:1 to about 20:1. In one embodiment the ratio is about 2.3:1.

The prepolymer formed by reacting at least the at least one polyol and the at least one isocyanate, may then be reacted with at least one chain extender to form at least one polyurethane elastomer. It is possible to use one or more chain extenders for the production of polyurethane elastomers of the embodiements of the present invention. For purposes of the embodiments of the invention, a chain extender is a material having two isocyanate-reactive groups per molecule and an equivalent weight per isocyanate-reactive group of less than 400, preferably less than 300 and especially from 31-125 daltons. Representative of suitable chain-extending agents include polyhydric alcohols, aliphatic diamines including polyoxyalkylenediamines, and mixtures thereof. The isocyanate reactive groups are preferably hydroxyl, primary aliphatic amine or secondary aliphatic amine groups. The chain extenders may be aliphatic or cycloaliphatic, and are exemplified by triols, tetraols, diamines, triamines, aminoalcohols, and the like. Representative chain extenders include ethylene glycol, diethylene glycol, 1,3-propane diol, 1,3- or 1,4-butanediol, dipropylene glycol, 1,2- and 2,3-butylene glycol, 1,6-hexanediol, neopentylglycol, tripropylene glycol, ethylene diamine, 1,4-butylenediamine, 1,6-hexamethylenediamine, 1,5-pentanediol, 1,6-hexanediol, 1,3-cyclohexandiol, 1,4-cyclohexanediol; 1,3-cyclohexane dimethanol, 1,4-cyclohexane dimethanol, N-methylethanolamine, N-methyliso-propylamine, 4-aminocyclohexanol, 1,2-diaminotheane, 1,3-diaminopropane, hexylmethylene diamine, methylene bis(aminocyclohexane), isophorone diamine, 1,3- or 1,4-bis(aminomethyl)cyclohexane, diethylenetriamine, and mixtures or blends thereof. The chain extenders may be used in an amount from about 0.5 to about 20, especially about 2 to about 16 parts by weight per 100 parts by weight of the polyol component.

It may be preferred that the chain extender be selected from the group consisting of amine terminated polyethers such as, for example, JEFFAMINE D-400 from Huntsman Chemical Company, 1,5-diamino-3-methyl-pentane, isophorone diamine, bis(aminomethyl)cyclohexane and isomers thereof, ethylene diamine, diethylene triamine, aminoethyl ethanolamine, triethylene tetraamine, triethylene pentaamine, ethanol amine, lysine in any of its stereoisomeric forms and salts thereof, hexane diamine, hydrazine and piperazine.

The chain extender may be modified to have pendant functionalities to further provide crosslinker, flame retardation, or other desirable properties. Suitable pendant groups include carboxylic acids, phosphates, halogenation, etc.

In the embodiments of the present invention, a chain extender may be employed in an amount sufficient to react with from about zero to about 100 percent of the isocyanate functionality present in the prepolymer, based on one equivalent of isocyanate reacting with one equivalent of chain extender. The remaining isocyanate may be reacted out with water. Alternatively, in embodiments of the present invention, the chain extender may be present in an excess, that is more chain extender functional groups are present than there ate isocyanate functional groups. Thus, the prepepolymers may chain extended at various stoichiometries (i.e. the amount of isocyanate groups of the prepolymers in relation to the amount of functional groups of the chain extenders). In one embodiment, the stoichiometry may be at least 85%. In one embodiment, the stoichiometry may be at least 90%. In one embodiment, the stoichiometry may be at least 92%. In one embodiment, the stoichiometry may be at least 94%. In one embodiment, the stoichiometry may be at least 95%. In one embodiment, the stoichiometry may be at least 96%. In one embodiment, the stoichiometry may be at least 97%. In one embodiment, the stoichiometry may be at least 98%. In one embodiment, the stoichiometry may be at least 99%. In one embodiment, the stoichiometry may be at least 100%. In one embodiment, the stoichiometry may be at least 101%. In one embodiment, the stoichiometry may be at least 102%. In one embodiment, the stoichiometry may be at least 103%. In one embodiment, the stoichiometry may be at least 105%. In one embodiment, the stoichiometry may be at least 110%. Percentages under 100% indicate an excess of isocyante groups, while percentages above 100% indicate an excess of chain extender functional groups. The stoichiometry may, in one embodiment, be up to 95%. In one embodiment the stoichiometry may be up to 96%. In one embodiment the stoichiometry may be up to 97%. In one embodiment the stoichiometry may be up to 98%. In one embodiment the stoichiometry may be up to 99%. In one embodiment the stoichiometry may be up to 100%. In one embodiment the stoichiometry may be up to 101%. In one embodiment the stoichiometry may be up to 102%. In one embodiment the stoichiometry may be up to 103%. In one embodiment the stoichiometry may be up to 105%. In one embodiment the stoichiometry may be up to 110%. In one embodiment the stoichiometry may be up to 115%. In certain embodiments, the stoichiometry is between about 95% and about 102%.

It may be desirable to allow water to act as a chain extender and react with some or all of the isocyanate functionality present. A catalyst can optionally be used to promote the reaction between a chain extender and an isocyanate. When chain extenders of the present invention have more than two active hydrogen groups, then they can also concurrently function as crosslinkers.

In embodiments of the present invention, the chain extender may include a mixture of any of the above mentioned chain extenders. The chain extender mixture may include both a diol and a non-aromatic diamine, including the diols and amines recited above.

The resulting polyurethane elastomer is a thermoset material with hard segment ratios of at least about 10%. In one embodiment, the hard segment ratio is at least about 20%. In one embodiment, the hard segment ratio is at least about 25%. In one embodiment, the hard segment ratio is at least about 30%. In one embodiment, the hard segment ratio is at least about 35%. In one embodiment, the hard segment ratio is at least about 40%. In one embodiment, the hard segment ratio is at least about 45%. In one embodiment, the hard segment ratio is at least about 50%. The hard segment ratios may be up to about 20%. In one embodiment, the hard segment ratio is up to about 25%. In one embodiment, the hard segment ratio is up to about 30%. In one embodiment, the hard segment ratio is up to about 35%. In one embodiment, the hard segment ratio is up to about 40%. In one embodiment, the hard segment ratio is up to about 45%. In one embodiment, the hard segment ratio is up to about 50%. In one embodiment, the hard segment ratio is up to about 60%. In certain embodiments, the hard segment ratio is between about 35% and about 45%. The hard segment refers to the portion of the polyurethane formed between the chain extender and the isocyanate. The hard segment is observed to provide resistance to deformation, increasing polymer modulus and ultimate strength. The amount of hard segments is estimated by calculation of the ratio of weight of isocyante and chain extender to total polymer weight. Elongation and resilience are directly related to the rubbery “soft” segment. Increase of the hard segment reduces the soft segment content, which results in change of microdomain structure in the PU elastomers. At 35% hard segment content, it is expected that the microdomain structure represents dispersed hard domain in continuous soft phase. While at 45% hard segment content, a bi-continuous microdomain structure is expected.

The elastomers of the various embodiments of the present invention may demonstrate improved hardness, tensile strength, elongation, compression set and Bashore rebound at the same hard segment content as for example H₁₂MDI based elastomers. The elastomers of the various embodiments of the present invention utilizing the aliphatic isocyantes may also be significantly harder than H₁₂MDI based elastomers at the same hard segment content. For example, elastomers of the various embodiments of the invention may have a Shore A hardness of at least 70. In one embodiment, the Shore A hardness is at least about 75. In one embodiment, the Shore A hardness is at least about 80. In one embodiment, the Shore A hardness is at least about 85. In one embodiment, the Shore A hardness is at least about 88. In one embodiment, the Shore A hardness is at least about 90. In one embodiment the Shore A hardness is 92, and in another 93. As a result, the aliphatic isocyanate based elastomers may achieve the same level of hardness as H₁₂MDI based elastomers at a much lower hard segment content. Therefore, less isocyanate may be required to reach a given hardness. As aliphatic isocyanates are the most costly component among the building blocks, lower levels of aliphatic isocyanate in the system can significantly reduce total system cost.

The resulting aliphatic isocyanate based elastomers have an improved compression set which indicates a greater ability of theses elastomers to retain elastic properties after prolonged action of compressive stresses. This makes them more suitable for stressing services than for example H₁₂MDI based elastomers. The actual stressing services may involve the maintenance of a definite deflection, the constant application of a known force, or the rapidly repeat deformation and recovery resulting from intermittent compressive forces.

In embodiments of the present invention, the elastomers may have a Method B compression set of less than about 38%. In one embodiment, the Method B compression set is less than about 35%. In one embodiment, the Method B compression set is less than about 34%. In one embodiment, the Method B compression set is less than about 32%. In one embodiment, the Method B compression set is less than about 30%. In one embodiment, the Method B compression set is less than about 29%.

In embodiments of the present invention, the elastomers may have Bashore rebound of at least about 42%. In one embodiment, the Bashore rebound is at least about 43%. In one embodiment, the Bashore rebound is at least about 44%. In one embodiment, the Bashore rebound is at least about 45%. In one embodiment, the Bashore rebound is at least about 46%. In one embodiment, the Bashore rebound is at least about 47%. In one embodiment, the Bashore rebound is at least about 48%. In one embodiment, the Bashore rebound is at least about 49%. In one embodiment, the Bashore rebound is at least about 50%. In one embodiment, the Bashore rebound is at least about 51%. In one embodiment, the Bashore rebound is at least about 52%.

The dynamic stressing produces a compression set, however, its effect as a whole is simulated more closely by hysteresis tests, such as dynamic mechanical analysis.

Dynamic mechanical analysis of urethane elastomers may be performed using a Dynamic Mechanical Analyzer. A good compound for dynamic applications is generally represented by low tan δ values and constant modulus values over the working temperature range in which the parts will be utilized. As tan δ=G″/G′, where G″ is the loss modulus and G′ is the storage modulus, a lower tan δ value means that energy transferred to heat is much lower than energy stored. Therefore, lower heat buildup occurs in high-speed, high-load bearing applications.

The elastomers of the various embodiments of the invention may display a low rate of change of the elastic modulus, G′, over a various range of temperatures. The rate change may act as a determination of the elastomers ability to maintain the modulus constant over the various temperature ranges. The rate of change (ΔG′_{%}) is calculated by determining a first G′ (G′₁) at a first temperature (T₁), determining a second G′ (G′₂) at a second temperature (T₂), and calculating according to equation 5:

ΔG′_{%}=(G′₁−G′₂)*100/G′₁ (5)

For example, ΔG′_{%} may at a temperature range of between about 0° C. and about 150° C. be less than about 98%, preferably less than about 94%.

ΔG′_{%} may at a temperature range of between about 0° C. and about 100° C. be less than about 90%. In one embodiment ΔG′_{%} is less than about 85%. In one embodiment ΔG′_{%} is less than about 75%. In one embodiment ΔG′_{%} is less than about 72%.

ΔG′_{%} may at a temperature range of between about 100° C. and about 150° C. be less than about 90%. In one embodiment ΔG′_{%} is less than about 88%. In one embodiment ΔG′_{%} is less than about 78%.

ΔG′_{%} may at a temperature range of between about 100° C. and about 125° C. be less than about 70%. In one embodiment ΔG′_{%} is less than about 60%. In one embodiment ΔG′_{%} is less than about 50%. In one embodiment ΔG′_{%} is less than about 40%. In one embodiment ΔG′_{%} is less than about 30%. In one embodiment ΔG′_{%} is less than about 20%. In one embodiment ΔG′_{%} is less than about 15%. In one embodiment ΔG′_{%} is less than about 12%.

ΔG′_{%} may at a temperature range of between about 75° C. and about 125° C. be less than about 85%. In one embodiment ΔG′_{%} is less than about 70%. In one embodiment ΔG′_{%} is less than about 65%. In one embodiment ΔG′_{%} is less than about 55%.

ΔG′_{%} may at a temperature range of between about 50° C. and about 100° C. be less than about 85%. In one embodiment ΔG′_{%} is less than about 75%. In one embodiment ΔG′_{%} is less than about 65%. In one embodiment ΔG′_{%} is less than about 55%.

ΔG′_{%} may at a temperature range of between about 25° C. and about 75° C. be less than about 70%. In one embodiment ΔG′_{%} is less than about 60%. In one embodiment ΔG′_{%} is less than about 50%. In one embodiment ΔG′_{%} is less than about 40%. In one embodiment ΔG′_{%} is less than about 30%. In one embodiment ΔG′_{%} is less than about 27%.

ΔG′_{%} may at a temperature range of between about 0° C. and about 75° C. be less than about 75%. In one embodiment ΔG′_{%} is less than about 70%. In one embodiment ΔG′_{%} is less than about 65%. In one embodiment ΔG′_{%} is less than about 60%. In one embodiment ΔG′_{%} is less than about 55%. In one embodiment ΔG′_{%} is less than about 50%. In one embodiment ΔG′% is less than about 47%.

ΔG′_{%} may at a temperature range of between about 0° C. and about 50° C. be less than about 70%. In one embodiment ΔG′_{%} is less than about 65%. In one embodiment ΔG′_{%} is less than about 60%. In one embodiment ΔG′_{%} is less than about 55%. In one embodiment ΔG′_{%} is less than about 50%. In one embodiment ΔG′_{%} is less than about 45%. In one embodiment ΔG′_{%} is less than about 40%. In one embodiment ΔG′_{%} is less than about 38%.

The elastomer according to the various ambodiments of the invention may at temperatures of at least about 50° C. have a tan δ of less than about 0.09, preferably less than about 0.07, preferably less than about 0.06, preferably less than about 0.05, or preferably less than about 0.04. At temperatures of at least about 75° C., the elastomer may have a tan δ of less than about 0.09, preferably less than about 0.07, preferably less than about 0.06, preferably less than about 0.05, preferably less than about 0.04, or preferably less than about 0.03. At temperatures of at least about 100° C., the elastomer may have a tan δ of less than about 0.2, preferably less than about 0.15, preferably less than about 0.12, preferably less than about 0.09, preferably less than about 0.06, or preferably less than about 0.03. At temperatures of at least about 125° C., the elastomer may have a tan δ of less than about 1.8, preferably less than about 1.4, preferably less than about 1.0, preferably less than about 0.6, preferably less than about 0.3, preferably less than about 0.2, preferably less than about 0.16, preferably less than about 0.12, preferably less than about 0.08, or preferably less than about 0.04. At temperatures of at least about 150° C., the elastomer may have a tan δ of less than about 1.8, preferably less than about 0.16, preferably less than about 0.12, preferably less than about 0.08, or preferably less than about 0.06.

Furthermore, the elastomers of the various embodiments of the invention may have an elastic modulus of at least 10⁶ Pa at temperatures of at least about 100° C. In one embodiment the elastomer may an elastic modulus of at least 10⁷ Pa at temperatures of at least about 100° C. In one embodiment the elastomer may an elastic modulus of at least 10⁶ Pa at temperatures of at least about 125° C. or 150° C.

The elastomers of the various embodiments of the invention may be used in a multitude of applications. The elastomers may in some embodiment be applied as films, coatings, layers, laminates, or as one component of a multiple component application. The elastomers of the various embodiments of the invention may be used in glasses, lenses, ballistic glass, architecturally shaped windows, hurricane windows, armor, golf balls, bowling balls, rollerblade wheels, roller-skate wheels, skate-board wheels, greenhouse covers, coatings, floor coatings, outdoor coatings, photovoltaic cells, face masks, personal protection gear, privacy screens, etc.

### EXAMPLES

The following examples are provided to illustrate the embodiments of the invention, but are not intended to limit the scope thereof. All parts and percentages are by weight unless otherwise indicated.

The following materials were used:
Polyol 1: A polycaprolactone polyester diol with an average molecular weight of about 2000. Available from The Dow Chemical Company as TONE* 2241.
ADI: An approximate 50/50 mixture of 1,3-bis(isocyanatomethyl)cyclohexane and 1,4-bis(isocyanatomethyl)cyclohexane made according to WO 2007/005594.
H₁₂MDI: 4,4′-methylene bis(cyclohexyl isocyanate). Available from Bayer AG as Desmodur W. This isocyanate is also known as H₁₂MDI.
BDO: 1,4-butanediol. Available from International Specialty Products.
HB 6536 MDI prepolymer based on caprolactone polyols (Polyol 1), with an NCO content of about 7% to about 7.5%. Available from The Dow Chemical Company as VORASTAR* HB
HB 6544 MDI prepolymer based on caprolactone polyols (Polyol 1), with an NCO content of about 9.9% to about 10.5%. Available from The Dow Chemical Company as VORASTAR* HB 6544 Polymer.
   *TONE and VORASTAR are trademarks of The Dow Chemical Company

Polyurethane elastomers are obtained by first preparing prepolymers at various ratios which are then reacted with a chain extender and cured. The prepolymers are prepared from Polyol 1 and diisocyanate at various NCO/OH ratios at 85° C. for 6 hours under a nitrogen atmosphere. The amounts of the components used are given in the following tables. The extent of reaction of hydroxyl group with isocyanate is determined by an amine equivalent method (titration to determine NCO content). After the reaction is completed, the resulting prepolymer is placed under vacuum at 70° C. to remove bubbles. The prepolymer and curing agent are then mixed well at different stoichiometric ratios with a Falcktek DAC 400 FV Speed Mixer and then poured into a mold which is pre-heated to 115° C. The resulting polyurethane elastomers are demolded after several hours of curing depending on the reactivity of the various prepolymers, and are further postcured at 110° C. for 16 hours in air. After the postcure, the elastomers are aged at room temperature for at least 4 weeks before they are subjected to various tests.

The hardness (Shore A) is measured according to ASTM D 2240, Test Method for Rubber Property—Durometer Hardness. The higher the value, the harder the elastomer.

Stress-Strain Properties—Tensile Strength at Break, Ultimate Elongation, 100% and 300% Modulus (Stress at 100% and 300% Elongation); ASTM D 412, Test Methods for Rubber Properties in Tension.

Tear strength is measured according to ASTM D 470 and ASTM D 624, Test Methods for Rubber Property—Tear Resistance. The higher the value, the more tear resistant the elastomer.

Compression set is measured by Method B, ASTM D 395, Test Methods for Rubber Property—Compression Set. The higher the value, the more prone the elastomer to lasting deformation when tested under a load.

Resilience, Bashore Rebound, is measured according to ASTM D 2632, Test Methods for Rubber Property—Resilience by Vertical Rebound. The higher the value the more resilient the elastomer.

Elastic modulus is used to designate the energy stored by material under cyclic deformation. It is the portion of the stress strain response which is in phase with the applied stress. The storage modulus is related to the portion of the polymer structure that fully recovers when an applied stress is removed. The storage modulus is determined using dynamic mechanical analysis (DMA) tests using a commercially available DMA instrument available from TA Instruments under the trade designation RSA III, using a rectangular geometry in tension. The test type is a Dynamic Temperature Ramp method with an initial temperature of −115.0° C. and a final temperature of 250.0° C. at a ramp rate of 3.0° C./min

Tan delta is used to designate the tangent of the phase angle between an applied stress and strain response in dynamic mechanical analysis. High tan delta values imply that there is a high viscous component in the material behavior and hence a strong damping to any perturbation will be observed. The tan delta is determined using the same instrument and methodology as described for the elastic modulus.

### Examples 1 and 2 and Comparative Examples 1 and 2

The composition and physical properties of polyurethane elastomers based on ADI (examples E1 and E2) and H₁₂MDI (comparative examples C1 and C2) at 35% and 45% hard segment contents are summarized in Table 1. The prepolymers are chain extended using 1,4-butanediol at 98% stoichiometry (i.e. a slight excess amount of isocyanate groups of the prepolymers in relation to the amount of hydroxyl groups of the 1,4-butanediol). With slight excess of isocyanate groups, the elastomers are expected to be lightly cross-linked. For both ADI and H₁₂MDI based elastomers, increasing hard segment content increases hardness, tensile strength and tear strength, but reduces elongation and Bashore rebound.

TABLE 1

| | E1 | C1 | E2 | C2 |
|---|---|---|---|---|
| Polyol 1 (g) | 100 | 100 | 100 | 100 |
| ADI (g) | 41.2 | — | 60.15 | — |
| H₁₂MDI (g) | — | 43.60 | — | 64.27 |
| BDO (g) | 19.85 | 10.05 | 22.66 | 16.99 |
| % NCO of prepolymer | 9.50 | 6.65 | 13.50 | 9.85 |
| Hardsegment Content, % | 35 | 35 | 45 | 45 |
| Hardness, A | 85 | 78 | 93 | 87 |
| Tensile Strength | 6620 | 2285 | 7315 | 2418 |
| Elongation | 680 | 575 | 640 | 450 |
| Tear Strength, | | | | |
| D 470, pli | 139 | 138 | 155 | 174 |
| D 624 Die C, pli | 428 | 375 | 495 | 451 |
| Compression Set | 33 | 38 | 30 | 42 |
| Method B, % | | | | |
| Bashore Rebound, % | 52 | 42 | 38 | 35 |
| Stoichiometry, % | 98 | 98 | 98 | 98 |

Comparing physical properties of ADI based elastomers to those based on H₁₂MDI at the same hard segment content, the ADI elastomers demonstrate improved hardness, tensile strength, elongation, compression set and Bashore rebound. Surprisingly, the ADI based elastomers are significantly harder than H₁₂MDI based elastomers at the same hard segment content. The results indicate that ADI based elastomers can achieve the same hardness as H₁₂MDI based elastomers at a lower hard segment content.

### Examples 3 and 4

Table 2 summarizes general mechanical properties of ADI based elastomers containing 45% hard segment content while varying the stoichiometry of hydroxyl groups to isocyanate groups.

TABLE 2

| | E3 | E2 | E4 |
|---|---|---|---|
| Polyol 1 (g) | 100 | 100 | 100 |
| ADI (g) | 60.15 | 60.15 | 60.15 |
| H₁₂MDI (g) | — | — | — |
| BDO (g) | 21.99 | 22.66 | 23.60 |
| % NCO of prepolymer | 13.50 | 13.50 | 13.50 |
| Hardsegment Content, % | 45 | 45 | 45 |
| Hardness, A | 93 | 93 | 92 |
| Tensile Strength | 7000 | 7315 | 6290 |
| Elongation | 625 | 640 | 1285 |
| Tear Strength, | | | |
| D 470, pli | 148 | 155 | 160 |
| D 624 Die C, pli | 449 | 495 | 523 |
| Compression Set | 28 | 30 | 69 |
| Method B, % | | | |
| Bashore Rebound, % | 40 | 38 | 38 |
| Stoichiometry, % | 95 | 98 | 102 |

The results indicate elongation, tear strength and compression set increase with increasing stoichiometry, while tensile strength and resilience decrease slightly at decreasing stoichiometry.

### Comparative Examples 3 and 4

Table 3 compares the performance of ADI based elastomers (E1 and E2) to those based on methylene diphenyl 4,4′-diisocyanate (MDI) at similar hard segment contents. VORASTAR HB 6536 (C3) and VORASTAR HB 6544 (C4) are MDI prepolymers based on caprolactone polyols. The results indicate the ADI based elastomers match the performance of MDI based elastomers at both 35% and 45% hard segment contents. While demonstrating improved stress-strain properties, the ADI based elastomers only show minor deficiencies in compression set and resilience.

TABLE 3

| | C3 | E1 | C4 | E2 |
|---|---|---|---|---|
| Polyol 1 (g) | — | 100.0 | — | 100.0 |
| ADI (g) | — | 41.20 | — | 60.15 |
| BDO (g) | 7.34 | 19.85 | 10.50 | 22.66 |
| HB 6536 (g) | 100 | — | — | — |
| HB 6544 (g) | — | — | 100 | — |
| % NCO of prepolymer | 7.00 | 9.50 | 10.20 | 13.50 |
| Hardsegment Content, % | 35 | 35 | 44 | 45 |
| Hardness, A | 85 | 85 | 95 | 93 |
| Tensile Strength | 6000 | 6620 | 6285 | 7315 |
| Elongation | 620 | 680 | 490 | 640 |
| Tear Strength, | | | | |
| D 470, pli | 125 | 139 | 165 | 148 |
| D 624 Die C, pli | 450 | 428 | 605 | 449 |
| Compression Set | 20 | 33 | 26 | 30 |
| Method B, % | | | | |
| Bashore Rebound, % | 56 | 52 | 50 | 38 |
| Stoichiometry, % | 98 | 98 | 98 | 98 |

### Comparative Examples 5 and 6

Comparative examples C5 and C6 are made according to examples 5 and 6, respectively, of U.S. Patent Application No. 2004/0087754. This method is a so-called one-shot method for the production of thermoplastic polyurethanes wherein the isocyanate is added to a mixture of polyol, chain extender and catalyst in one step. In contrast the elastomers of the embodiments of the present invention as given in E1-E4 produced in a two step process wherein a prepolymer is made followed by the addition of chain extender. The results are given in Table 4 along with examples E1 and E2 for comparison:

TABLE 4

| | E1 | C5 | E2 | C6 |
|---|---|---|---|---|
| Polyol 1 (g) | 100 | 100 | 100 | 100 |
| ADI (g) | 41.20 | 32.51 | 60.15 | 48.92 |
| BDO (g) | 19.85 | 10.27 | 22.66 | 17.73 |
| % NCO of prepolymer | 9.50% | — | 13.50 | — |
| Hardsegment Content, % | 35 | 30 | 45 | 40 |
| Hardness, A | 85 | 73 | 93 | 86 |
| Tensile Strength | 6620 | 6235 | 7315 | 6472 |
| Elongation | 680 | 939 | 640 | 896 |
| Tear Strength, | | | | |
| D 470, pli | 139 | | 155 | |
| D 624 Die C, pli | 428 | 416 | 495 | 484 |
| Compression Set | 33 | 37 | 30 | 41 |
| Method B, % | | | | |
| Bashore Rebound, % | 52 | 42 | 38 | 35 |
| Stoichiometry, % | 98 | 102* | 98 | 102 |

The two-step prepolymer process (used to make E1 and E2) produces harder elastomers with improved tensile strength, tear strength, compression set and resilience as than does the one-shot process (used to make C5 and C6). These properties, especially resilience and compression set are critical to heavy loaded dynamic applications.

### Dynamic Viscolelastic Properties

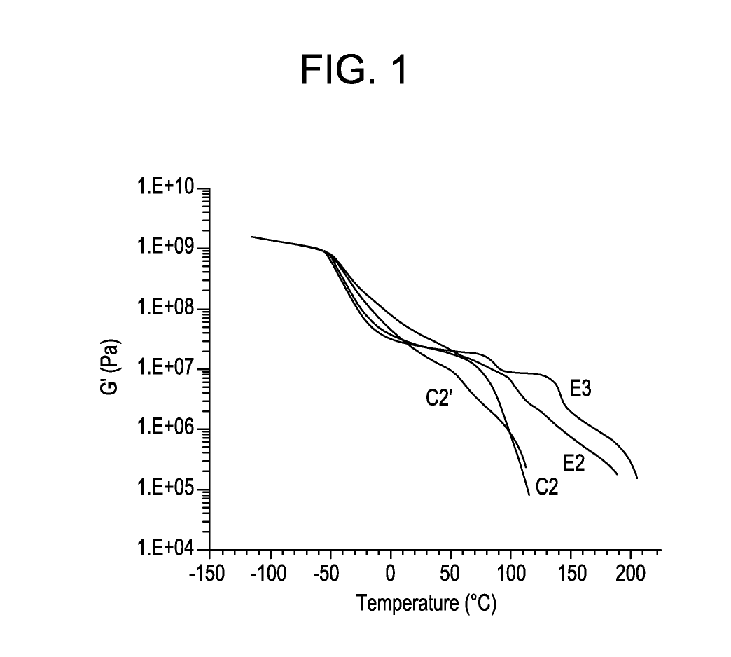

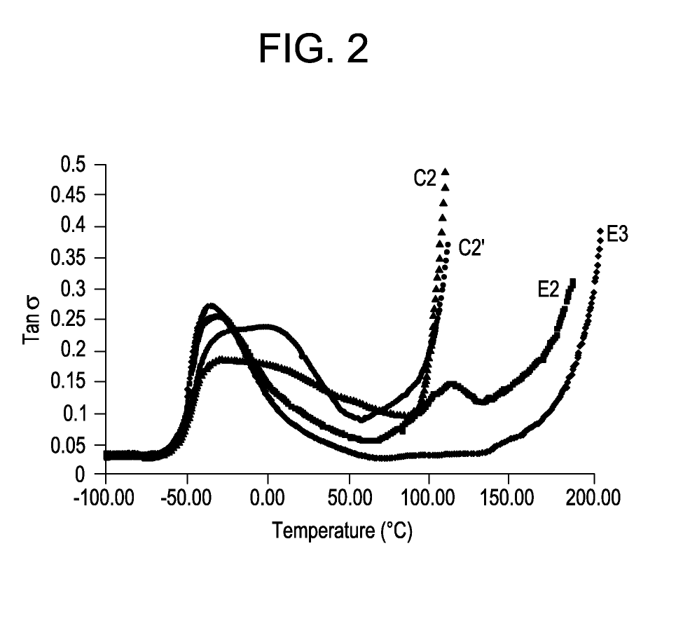

FIG. 1 shows the elastic modulus (shear storage modulus) and FIG. 2 shows tan δ values of elastomers containing 45% hard segment content for ADI (E2 and E3) and H₁₂MDI (C2 and C2′, a 1.02 stoichometric version of C2) based elastomers with varying stoichiometry using BDO as the chain extender. It is believed the sharp drop in elastic modulus starting at about −50° C. as shown FIG. 1, corresponds to glass transition temperatures of the soft segment, while decline in modulus at the higher temperature range corresponds to melting of the hard segment (softening temperature). The two temperatures define the working temperature range of an elastomer. A wider working temperature range may be desirable as it allows the elastomer to be utilized at both lower and higher temperature applications. It is clear that the ADI based elastomers have a wider working temperature range than those based on H₁₂MDI, as evident by a lower glass transition temperature and a higher softening temperature of the ADI based elastomers. In addition, the ADI based elastomers also exhibit enhanced ability in maintaining the modulus constant over the working temperature range. As elastic modulus measures a material's ability to carry load, a decline in modulus over increasing temperature, as shown in the H₁₂MDI based elastomers, may not be desirable for dynamic applications. The increase of stoichiometry from 95% to 102% affects modulus retention and lowers softening temperature considerably in all elastomers.

Table 5 shows the elastic modulus, G′, and the rate of change (in %) of G′, over a various range of temperatures.

TABLE 5

| | E2 | E3 | C2 | C2′ |
|---|---|---|---|---|
| G′1 (T1 = 0° C.) | 38400000 | 33800000 | 79300000 | 47087760 |
| G′2 (T2 = 50° C.) | 18700000 | 21000000 | 21400000 | 10569429 |
| ΔG′ % (0-50° C.) | 51.30208 | 37.86982 | 73.01387 | 77.55377 |
| G′1 (T1 = 0° C.) | 38400000 | 33800000 | 79300000 | 47087760 |
| G′2 (T2 = 75° C.) | 13500000 | 18200000 | 10500000 | 2955318 |
| ΔG′ % (0-75° C.) | 64.84375 | 46.15385 | 86.75914 | 93.72381 |
| G′1 (T1 = 0° C.) | 38400000 | 33800000 | 79300000 | 47087760 |
| G′2 (T2 = 100° C.) | 6561471 | 9503733 | 889944.2 | 880079.4 |
| ΔG′ % (0-100° C.) | 82.91284 | 71.88245 | 98.87775 | 98.13098 |
| G′1 (T1 = 25° C.) | 25500000 | 24600000 | 39100000 | 19774764 |
| G′2 (T2 = 75° C.) | 13500000 | 18200000 | 10500000 | 2955318 |
| ΔG′ % (25-75° C.) | 47.05882 | 26.01626 | 73.14578 | 85.0551 |
| G′1 (T1 = 50° C.) | 18700000 | 21000000 | 21400000 | 10569429 |
| G′2 (T2 = 100° C.) | 6561471 | 9503733 | 889944.2 | 880079.4 |
| ΔG′ % (50-100° C.) | 64.91192 | 54.74413 | 95.84138 | 91.67335 |
| G′1 (T1 = 100° C.) | 6561471 | 9503733 | 889944.2 | 880079.4 |
| G′1 (T2 = 125° C.) | 2211318 | 8454766 | | |
| ΔG′ % (100-125° C.) | 66.29843 | 11.03742 | | |
| G′1 (T1 = 75° C.) | 13500000 | 18200000 | 10500000 | 2955318 |
| G′1 (T2 = 125° C.) | 2211318 | 8454766 | | |
| ΔG′ % (75-125° C.) | 83.61986 | 53.54524 | | |
| G′1 (T1 = 100° C.) | 6561471 | 9503733 | 889944.2 | 880079.4 |
| G′2 (T2 = 150° C.) | 823324.8 | 2109654 | | |
| ΔG′ % (100-150° C.) | 87.45213 | 77.80184 | | |
| G′1 (T1 = 0° C.) | 38400000 | 33800000 | 79300000 | 47087760 |
| G′2 (T2 = 150° C.) | 823324.8 | 2109654 | | |
| ΔG′ % (0-150° C.) | 97.85593 | 93.75842 | | |

The results in table 5 indicate that the ADI based elastomers (E2 and E3) have a significantly lower rate of change of G′ in the various selected ranges of temperatures than do the H₁₂MDI (C2 and C2′) based elastomers. The lower rate of change of G′ is an indication of the ADI elastomers ability to maintain a high modulus over the various temperature ranges. Furthermore, it can be seen that the ADI elastomer made at 0.95 stoichiometry (E3) exhibit higher overall modulus values and lower rates of change over the various selected temperature ranges than the ADI elastomer made at 0.98 stoichiometry (E2).

The peak in the Tan δ curves shown in FIG. 2 relates to glass transition of the soft segment in the polyurethane elastomers. Tg of the ADI based elastomers is about −34° C., lower than Tg of −25° C. in the H₁₂MDI based elastomers. In addition, the peak of the ADI based elastomers is sharper and narrower than that of the H₁₂MDI based elastomers. Peak intensity and shape represent damping properties of the elastomers. Considering the elastomers are based on the same polyol backbone, the difference in Tg between the ADI and H₁₂MDI based elastomers may be attributed to the degree of phase mixing in the elastomers. The steep increase in Tan δ value at a higher temperature corresponds to melting of the hard segment (softening temperature). Increase of stoichiometry not only increases Tan δ values over the working temperature range, but also lowers the softening temperature. It may be seen in FIGS. 1 and 2 that the ADI based elastomers are better in maintaining modulus over a much wider working temperature range, and have much lower Tan δ values than the H₁₂MDI based elastomers. Tan δ values at 50, 75, 100, 125, and 150° C. are given in Table 6.

TABLE 6

| | E2 | E3 | C2 | C2′ |
|---|---|---|---|---|
| Tan δ (T = 50° C.) | 0.05875 | 0.03562 | 0.11908 | 0.09391 |
| Tan δ (T = 75° C.) | 0.06559 | 0.02550 | 0.09586 | 0.11440 |
| Tan δ (T = 100° C.) | 0.12420 | 0.02875 | 0.21209 | 0.20254 |
| Tan δ (T = 125° C.) | 0.11955 | 0.03118 | 1.80153 | — |
| Tan δ (T = 150° C.) | 0.13930 | 0.05652 | — | — |

While the foregoing is directed to embodiments of the present invention, other and further embodiments of the invention may be devised without departing from the basic scope thereof, and the scope thereof is determined by the claims that follow.

1. A polyurethane elastomer, comprising:
the reaction product of at least a prepolymer and a chain extender, wherein the prepolymer comprises the reaction product of at least one polyol and at least one aliphatic diisocyanate, the chain extender is at least one of a diol or a non-aromatic diamine, the aliphatic diisocyanate comprises a mixture of 1,3-bis(isocyanatomethyl)cyclohexane and 1,4-bis(isocyanatomethyl)cyclohexane, and wherein the polyurethane elastomer has a change in elastic modulus of less than about 94% over a temperature range of between about 0° C. and about 150° C.

2. The polyurethane elastomer of claim 1, wherein the change in elastic modulus is less than about 90% over a temperature range of between about 0° C. and about 100° C.

3. The polyurethane elastomer of claim 1, wherein the change in elastic modulus is less than about 85% over a temperature range of between about 75° C. and about 125° C.

4. The polyurethane elastomer of claim 1, wherein the change in elastic modulus is less than about 85% over a temperature range of between about 50° C. and about 100° C.

5. The polyurethane elastomer of claim 1, wherein the change in elastic modulus is less than about 70% over a temperature range of between about 25° C. and about 75° C.

6. A polyurethane elastomer, comprising:
the reaction product of at least a prepolymer and a chain extender, wherein the prepolymer comprises the reaction product of at least a polyol and an aliphatic diisocyanate, the chain extender comprises at least one of a diol or a non-aromatic diamine, and wherein the polyurethane elastomer has at least one of a Shore A hardness of at least 90 at a hard segment content of between about 40 and about 50, a Shore A hardness of at least 85 at a hardsegment content of between about 30 and about 40, and a B ashore Rebound of at least 45%.

7. The polyurethane elastomer of claim 1, wherein the polyurethane elastomer has Bashore Rebound of at least 50%.

8. The polyurethane elastomer of claim 1, wherein the polyurethane elastomer has an elastic modulus of at least 1.2*10⁶ Pa at temperatures of at least about 100° C.

9. The polyurethane elastomer of claim 1, wherein the polyurethane elastomer has an elastic modulus of at least 10⁷ Pa at temperatures of at least about 100° C.

10. A polyurethane elastomer, comprising:
the reaction product of at least a prepolymer and a chain extender, wherein the prepolymer comprises the reaction product of at least a polyol and an aliphatic diisocyanate, the chain extender comprises at least one of a diol or a non-aromatic diamine, the aliphatic diisocyanate comprises a mixture of 1,3-bis(isocyanatomethyl)cyclohexane and 1,4-bis(isocyanatomethyl)cyclohexane, and wherein the polyurethane elastomer has a tan δ of less than about 0.09 at temperatures of at least about 50° C.

11. The polyurethane elastomer of claim 10, wherein the tan δ is less than about 0.04.

12. The polyurethane elastomer of claim 10, wherein the polyol comprises a polycaprolactone polyester diol.

13. The polyurethane elastomer of claim 10, wherein the aliphatic diisocyanate comprises a mixture of 1,3-bis(isocyanatomethyl)cyclohexane and 1,4-bis(isocyanatomethyl)cyclohexane.

14. The polyurethane elastomer of claim 13, wherein the aliphatic diisocyanate comprises a mixture of 1,3-bis(isocyanatomethyl)cyclohexane and 1,4-bis(isocyanatomethyl)cyclohexane at a weight ratio of 1,3-bis(isocyanatomethyl)cyclohexane to 1,4-bis(isocyanatomethyl)cyclohexane of about 80:20 to about 20:80.

15. The polyurethane elastomer of claim 14, wherein the ratio is about 55:45 to about 45:55.

16. The polyurethane elastomer of claim 10, wherein the chain extender comprises 1,4-butanediol.

17. The polyurethane elastomer of claim, 10 wherein the polyurethane elastomer has a Method B compression set is less than about 32%.

18. An article, comprising the polyurethane elastomer of claim 1.

19. The article of claim 18, the article comprising at least one of a film, a coating, a laminate, glasses, a lens, a ballistic glass, an architecturally shaped window, a hurricane window, an armor, a golf ball, a bowling ball, a rollerblade wheel, a roller-skate wheel, a skate-board wheel, a greenhouse cover, a floor coating, an outdoor coatings, a photovoltaic cell, a face mask, a personal protection gear, and a privacy screen.

20. A method for forming a polyurethane elastomer, comprising:
reacting at least a polyol and an aliphatic diisocyanate to form a prepolymer, and
reacting the prepolymer and a chain extender to form a polyurethane elastomer according to claim 1.
